(19) United States
(12) Patent Application Publication
(10) Pub. No.: US 2023/0179656 A1
(43) Pub. Date: Jun. 8, 2023

(54) METHOD FOR SYNCHRONISING DATA OF A DATABASE, COMPUTER PROGRAMME, DEVICE FOR PROCESSING DATA, AND MOBILE TERMINAL THEREFOR

(71) Applicant: HELMHOLTZ-ZENTRUM FÜR INFEKTIONSFORSCHUNG GMBH, Braunschweig (DE)

(72) Inventor: Gérard KRAUSE, Braunschweig (DE)

(21) Appl. No.: 17/995,218

(22) PCT Filed: Apr. 20, 2021
(86) PCT No.: PCT/EP2021/060219

§ 371 Date: Sep. 30, 2022

(30) Foreign Application Priority Data
Apr. 22, 2020 (EP) 20170842.7

(51) Int. Cl. H04L 67/1095; H04W 28/02; H04W 4/14

(52) U.S. Cl. CPC H04L 67/1095; H04W 28/0268; H04W 4/14

(57) ABSTRACT

The present invention relates to a method for synchronising data of a database (7) in mobile terminals (REST-CLIENT 5) with data in a central database (2), wherein data is transmitted between mobile terminal (REST-server 5) and the central database (2) optionally via the following data transmission channels channel a)—data messages in a signalling channel or voice channel of a mobile telephone network (4); channel b)—IP data packet in a data channel of a mobile telephone network (4) for data transmission via the Internet (3); or channel c)—IP data packet in a wireless local access network (WLAN) for data transmission via the Internet (3). The method is characterised by—checking the availability of the data transmission channels via the Internet (3) according to channel b) via IP data packets with a data channel of a mobile radio telephone network (4) or channel c) via IP data packets in a wireless local access network, and, if the data transmission channels are available,—synchronising the databases (2, 7) via the available channel b) or c) for IP data packets, and, if the data transmission channels are not available,—prioritising for synchronisation of the data to be transmitted,—dividing the data to be transmitted with the highest priority into data messages,—transmitting the data messages to be transmitted with the highest priority in channel a) as data messages in a signalling channel or voice channel of a mobile radio telephone network (4).

The invention relates to a method for synchronizing data from a database in mobile terminals with data in a central database, wherein data is transmitted between mobile terminal and the central database optionally via the following data transmission channels:
channel a)—data messages in a signaling channel or voice channel of a mobile telephone network,
channel b)—IP data packet in a data channel of a mobile radio telephone network for data transmission via the Internet or
channel c)—IP data packets in a wireless local access network (WLAN) for data transmission via the internet.

The invention further relates to a computer program comprising commands which, when the program is executed by a computer, cause this computer to execute the steps of the synchronization method.

Furthermore, the invention relates to a device for data processing, comprising a server and a central database communicatively connected to the server and to a mobile terminal for data processing, comprising a computer program configured to execute the method.

Synchronization of data in a central database with corresponding data in databases of mobile terminals is necessary and common for a wide range of applications. For this purpose, synchronization usually takes place automatically via IP communication over the internet. In this process IP data packets in the internet protocol format are transmitted over the internet and the protocol standard designated for this internet data channel is used to ensure error-free reception of the data packets at the receiver. This requires that the central database is connected to the mobile terminal via a stable internet connection. For this purpose, the mobile terminals can either use the data channel of the mobile radio telephone network or directly access the internet via a local access network (Wireless Local Area Network—WLAN).

The data transmission between the central database and the mobile terminals takes place using standardized communication protocols, which require a stable mobile radio network to provide the connection from the mobile terminal to a network router for internet access.

To support the identification and prevention of disease outbreaks, a system is known for recording disease cases in real time via mobile input devices (mobile terminals), the users of which are spread over a large geographical area. The data collected on a decentralized basis is combined in a central database and data from this central database is made available to other decentralized users by updating the databases in the mobile terminals. It is thus possible to manage the monitoring of outbreaks of infection and to provide a multidirectional exchange of information on case-based disease monitoring processes in an integrated manner. This requires extensive database synchronization between the mobile terminals and the central parts of the system.

A problem arises due to the fact that the mobile devices are also used in poorly accessible areas, which have only a poor mobile radio infrastructure. As a result, the users may sometimes not be able to transmit case data to the central server in the required time, or they may not receive important information from the central database in a timely manner, if at all.

On the basis of this, the object of the present invention is to create an improved method for synchronizing data from a database in mobile terminals with a central database, as well as a computer program, a device for processing data, and a mobile terminal therefor.

The object is achieved using the method as claimed in claim 1. Advantageous embodiments are described in the claims that refer back to that claim.

It is proposed to check the availability of the data transmission channels via the internet according to channel b) via IP data packets in a data channel of a mobile radio telephone network or channel c) via IP data packets in a wireless local access network. If such a data transmission is available via an internet data transmission channel, the database is synchronized via the available data-packet data transmission channel, as is conventional practice.

On the other hand, if the data transmission channels are not available via the internet according to channel b) or channel c), the data to be transferred for synchronization is prioritized. The data to be transmitted with the highest priority is divided into data messages and the data messages to be transmitted with the highest priority are transmitted in the data transmission channel a) as data messages in a synchronization channel or voice channel of a mobile radio telephone network.

Synchronization is thus ensured in the event that a data channel is not available for synchronization via the internet, at least for the essential data. For this purpose, only the data to be exchanged with the highest priority is first selected by prioritizing according to specified criteria and divided into data messages adapted for data transmission in a synchronization channel or voice channel. These data messages are usually much smaller than the IP data packets that can be used for transmission on the internet. After these high-priority data messages have been transmitted to the receiver as short messages via the synchronization or voice channel, they can be reassembled in the receiver to form data packets as are used for data transmission over the internet, or can be read out and assembled directly so that the content is used to update the database.

For this purpose, the data messages transmitted via the synchronization or voice channel can be read out and evaluated using a parser.

The method ensures a reliable way to transfer data from the mobile terminal to the central database or from the central database to the mobile terminal, even if data transmission via the internet is not possible for the mobile terminal, at least in order to exchange the time-critical information. The lower-priority data can then be synchronized either once the mobile terminal has a connection to the internet via a data channel again, or else the less time-critical data are also transmitted in due course according to their priority via the voice message service, e.g. in free regions of the synchronization channel, preferably as a short message service SMS message.

Even if the mobile terminal does not have a GPRS connection (General Packet Radio Service) or WLAN connection for a short period, an “offline mode” without an internet connection is possible in principle. The synchronization thus does not have to be delayed until a mobile telephone connection with GPRS quality or a better internet connection is established again. Synchronization is also possible for the higher-priority data, at least in part, if a GPRS connection is temporarily or permanently not possible but the mobile terminal has a connection to a mobile radio telephone network via which a short message service can be used.

Such a mobile radio telephone network can be a terrestrial mobile radio telephone network or a satellite-assisted network.

The data can preferably be transmitted via channel a) using a separate software application that is not coupled with the application for other types of synchronization and use of the database. This (low-bandwidth data synchronization—LBDS) software application can thus be operated in parallel. Therefore, if the data transmission channels are not available via the internet according to channel b) via IP data packets with a data channel of a mobile radio telephone network or channel c) via IP data packets in a wireless local access network, the data to be transmitted is transferred to a separate software application (LBDS-Client) on the mobile terminal or on a central computer (LBDS-Server) accessing the central database. The steps of
prioritizing for synchronization of the data to be transmitted,
dividing the data to be transmitted with the highest priority into data messages;
transmitting the data messages to be transmitted with the highest priority in channel a) as data messages in a signaling channel or voice channel of a mobile radio telephone network (4)

are then carried out by the separate software application.

For the synchronization, a confirmation message can be transmitted back after an error-free receipt of a data message in the voice channel of the mobile radio telephone network and a transmission of the data message can be repeated if no confirmation message has been received within a specified time. Therefore, for the synchronization a bidirectional data exchange is performed by means of a synchronization or voice channel, in which the receipt of a data message in the synchronization or voice channel is acknowledged with a confirmation message.

For the transmission of data from the central database to at least one mobile terminal, the availability of a data transmission channel via the internet according to channel b) or channel c) can be simply checked on the basis of the receipt of confirmation messages for the error-free reception of data packets. For such data transmission on the internet according to the Internet Protocol standard, a confirmation of receipt of a data packet in the respective return channel is normally provided anyway.

For the synchronization of the databases distributed in the mobile terminals by means of a central server accessing the central database, it can be difficult or even impossible for the central server or central sender to verify the availability of an internet data connection to a mobile terminal in advance. However, when transmitting IP data packets in an internet data channel to a mobile terminal, the central server can detect that data transmission in this internet data transmission channel is not possible by the absence of receipt confirmations. This allows the availability of data transmission channels via the internet to be checked by detecting unsuccessful data transmission attempts from the absence of confirmation messages.

After an IP data packet has been transmitted via the internet one or more times over a data transmission channel according to channel b) or channel c) without receiving a confirmation message, the data packets to be transmitted for the synchronization can then be prioritized and transmitted as data messages in a voice channel of a mobile radio telephone network according to their priority.

A short message service (SMS) of a mobile radio telephone network can be used to transmit the prioritized data packets as a data message via a voice channel of a mobile radio telephone network. The data is transferred in free regions of the logical synchronization channel. The voice channel comprises a logical user channel for the voice messages and a logical synchronization channel. Such a short messaging service is available for both terrestrial mobile telephone networks and for satellite-assisted mobile telephone networks.

The method can be used to monitor the spread of infections by exchanging data on the spread of infection between mobile terminals and a central database. It ensures that synchronization of the databases is possible in particular for time-critical information, even in areas with poor infrastructure.

For the prioritization, data about a result of an infection test relating to an individual case of infection can be transmitted in a timely manner with high priority, wherein if a data transmission channel via the internet is not available then the transmission is performed by means of data messages in a synchronization or voice channel, i.e. via text messages.

Before transmitting the data messages to be transmitted with the highest priority in channel a) as data messages in a signaling or voice channel of the mobile radio telephone network, management data can be transmitted. This can be, for example, cryptography keys, checksums and/or the number of data packets to be transmitted. This means, for example, that a key exchange can take place before the data packets are transmitted, so that the data packets, which were asynchronously encrypted by the sender with the exchanged (e.g. public) key, can be de-encrypted again at the receiver. It is also conceivable to perform a prior transmission of the number of data packets available for transmission, their total checksum, and/or the respective checksums of the individual data packets. This and other appropriate management data can be used and transmitted individually or in any combination.

The key exchange allows a simple means of ensuring asynchronous encryption of the data packets intended for synchronization of the databases. This applies in particular to the key exchange between a system of the central database (REST-Server) and an application set up independently of it which carries out the data exchange on channel a) (preferably with the short messaging service SMS).

The method can be implemented with a computer program that comprises commands which, when the computer program is executed by a computer, cause it to execute the method steps for synchronizing data in a database in the mobile terminal with data in a central database.

To carry out the method, a device for processing data can be provided, comprising a server and a central database communicatively connected to the server. The server is connected both to the internet and to a short messaging service of a mobile radio telephone network for bidirectional transmission of data via the logical synchronization channel for voice messages. The server has means for executing the method for synchronizing data in a database in the mobile terminal with data in a central database, which are preferably implemented as a computer program described above.

The method can also be implemented in a mobile terminal for processing data, which comprises a computer program described above for executing the method steps.

The invention is described in further detail below by reference to an exemplary embodiment and the enclosed drawings. In the drawings:

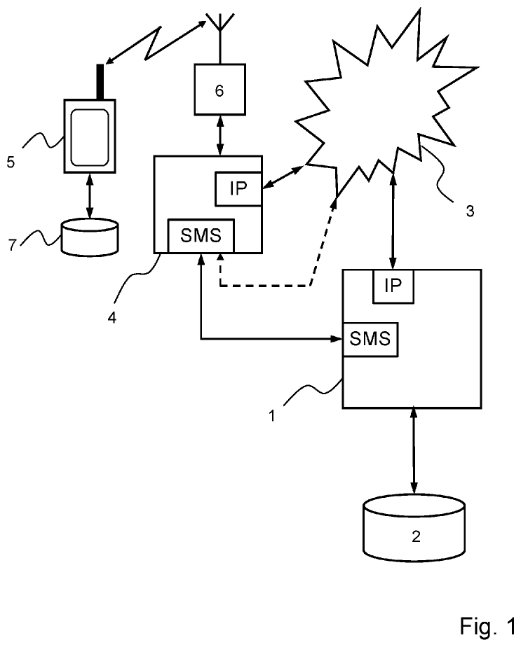

FIG. 1 shows a schematic block diagram of a system with central database and mobile terminal for synchronizing data;

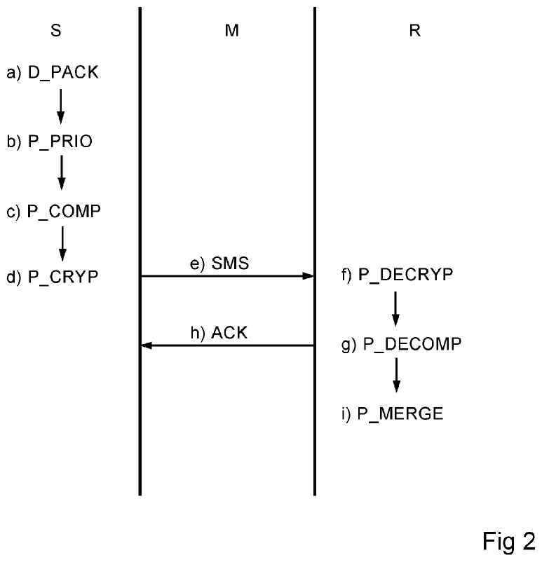

FIG. 2 shows a flowchart of the method for synchronizing data;

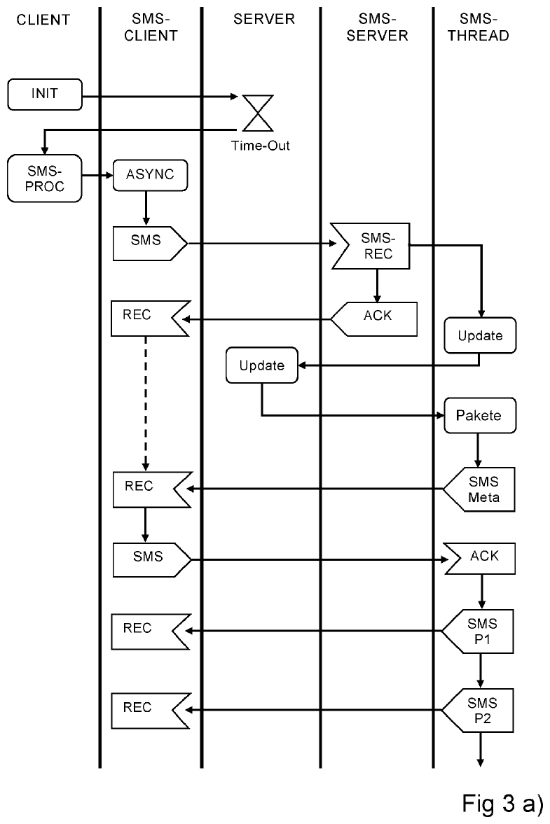

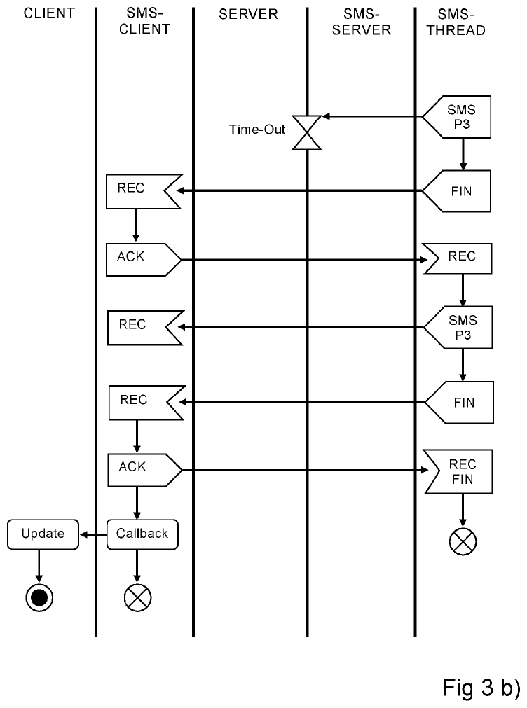

FIG. 3a) shows a first part of the process of data transmission for synchronizing data;

FIG. 3b) shows the second part of the process for synchronizing data in the event of an SMS data transmission error;

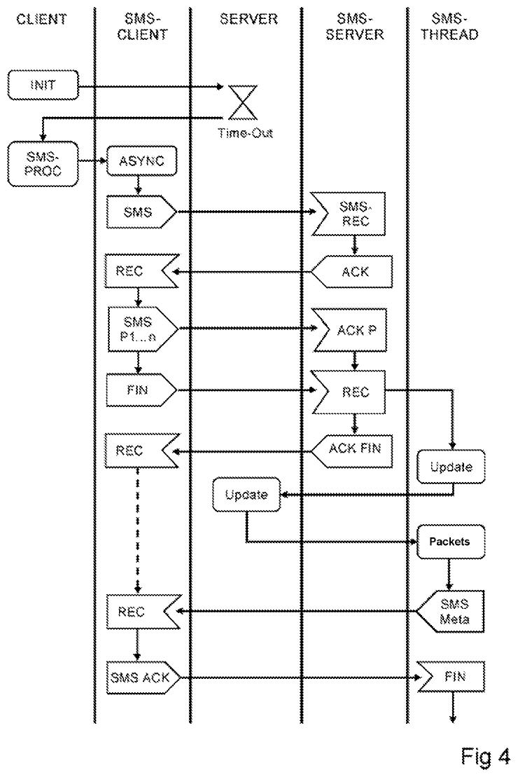

FIG. 4 shows an extended first part of the process according to FIG. 3a) of data transmission for synchronizing data, preceded by exchange of management data.

FIG. 1 shows a schematic block diagram of a system that comprises a server 1 and a central database 2 communicatively connected to that server 1. The server 1 is configured to carry out a communication via the internet 3 according to the Internet Protocol IP by means of a computer program in order thereby to transmit data to or receive data from other subscribers on the internet 3.

Furthermore, the central server 1 is configured to transmit data via the synchronization channel of a mobile radio telecommunications network 4 by means of a computer program and, if applicable, the connection to a suitable piece of telecommunication hardware. For this purpose, the central server 1 is configured to transmit data in the form of short messages via a short message service (SMS) of the mobile radio telephone network 4 to a mobile terminal 5 or to receive such messages SMS from a mobile terminal 5, either directly via a telephone channel or, if necessary, via the internet by using an IP connection. With other technologies it is also possible to use the voice channel, but not a data channel that is temporarily or permanently unavailable for data transmission with the IP protocol.

For this purpose, the mobile terminal 5 can be connected wirelessly in a known manner to at least one base station 6 of the mobile radio telephone network 4 in the communication cell of which the mobile terminal 5 is located.

The mobile terminal 5 also comprises a database 7, which is stored either in a memory of the mobile terminal 5 or in a separate memory connected to the mobile terminal 5 for data management and storage.

Then, in order to synchronize the data in the decentralized database 7 of the respective mobile terminal 5 with the data in the central database 2 so that both databases 2 and 7 have access to the current data, data is transmitted from the decentralized database 7 to the central server 1 and the central database 2 connected to it. In addition, the data currently available in the central database 2, which is destined for a particular mobile terminal 5 and its decentralized database 7, is synchronized in this decentralized database 7 by the central server 1 transmitting this data via the mobile telecommunications network to the respective mobile terminal 5.

The data of the central database 2 can be accessed via the central server 1 for the users connected to the internet 3 by means of a data packet transmission via the internet 3 in accordance with the IP protocol, depending on a corresponding authorization approval. Due to the relatively large data bandwidth available for this purpose, the access and synchronization are possible to an almost unlimited extent.

FIG. 2 shows a sketch of the sequence of the method for synchronizing data from a database 7 in the mobile terminal 5 with corresponding data in the central database 2. The procedure described below can either be used to transfer data from the decentralized database 7 of the mobile terminal 5 to the central database 2 or vice versa. For the transmission of data from the decentralized database 7, the mobile terminal 5 is designated as the sender S and the central server 1 with its central database 2 as the receiver R. The mobile telephone network 4 is labeled with M in FIG. 2.

In the event that no data transmission with the Internet Protocol IP is available via the internet 3, data is updated via the synchronization channel (also generally referred to as the logical control channel) or voice channel of the mobile telephone communication network 5. To do this, the following steps are performed:

a) D_PACK:

The data is assembled into data messages with a size adapted for transmission as short messages SMS. These data messages are provided with a suitable identifier so that the individual short messages can be recombined later.

b) P_PRIO:

The data items to be synchronized are prioritized. This is done on the basis of specified criteria. The information can be prioritized by content, in particular if appropriate capacity is available, as a function of the time that has elapsed in the meantime without synchronization and of the total amount of data to be synchronized.

If the method is used in the management and analysis of disease outbreaks, such as pandemics in particular, current results of an infection test for a patient can be assigned a very high priority, which requires the fastest synchronization possible. This efficiently reduces the notification and response times for implementing quarantine measures.

c) B_COMP:

The data packets currently to be transferred with high priority are compressed. Such a compression reduces the amount of data. Well-known methods of data compression can be used for this purpose.

d) P_CRYP:

The compressed data is encrypted in order to ensure data security, in particular with regard to personal data, when transmitting from the sender S to the receiver R.

The step a) of creating data packets of a size suitable for transmission as short messages can also take place only after compression and encryption, so that the encrypted data is further divided into individual SMS text messages (SMS data packets), which can be assigned and restored to the correct sequence at the receiver R by means of a sequential number.

e) SMS:

This compressed and encrypted data (i.e. data messages), packaged as short messages, is transmitted as a short message SMS to the receiver R via the short message service of the mobile telephone network M. This can be carried out via a terrestrial mobile radio telephone network 4 or via a satellite-assisted network or the like.

f) P_DECRYP:

The received short messages are de-encrypted at the receiver R. The encryption method agreed between the sender S and the receiver R is used for this purpose. Suitable encryption methods are conventional methods such as, in particular, asymmetric encryption, based for example on the AES (Advanced Encryption Standard).

g) P_DECOMP:

The received short messages are also decompressed. For this purpose, again suitable decompression methods are used as are known and available in data processing technology.

h) ACK:

After the receiver R has determined that a short message, or a data packet composed of short messages, has been correctly and completely received, the receiver R transmits a confirmation message ACK (Acknowledge Receipt) to the sender S. This means that the sender S knows that the short message has arrived safely and can delete the corresponding data packet from its transmission list as completed, or mark it as such.

i) P_MERG:

The receiver R merges the received short messages into data that it uses for updating the database 2, 7 of the receiver R.

In the event that no confirmation of receipt has been received in step h), the sender S can retransmit the corresponding data packet or short message. For this purpose, it is conceivable that the sender S will accept the unsuccessful transmission of a data packet or short message if no confirmation signal ACK has been received after a specified time (Time-Out).

The method provides an asynchronous, fault-tolerant communication protocol, which means that network outages and data transfers over several hours and days do not result in a loss of information. It is advantageous if a two-stage encryption is performed in which the control data and the user data are encrypted differently. This ensures maximum security. In addition, it means that the receiver R does not have to store the actual user data in the memory unencrypted during the asynchronous reception of the data packets, rather that the individual user data is de-encrypted only after the finalization of the transmission.

A symmetric encryption password can be communicated by the sender S to the receiver R when the services are started. For this purpose, a key memory can be used and the request can be asymmetrically encrypted so that only the receiver R itself can de-encrypt the content. In order to ensure that a data message has arrived, the receiver R sends a checksum CRC, for example one that is encrypted with an AES password, to the sender S. It is only thereafter that the synchronization can be carried out by the sender S in full.

A random sequence which is kept by the sender S and receiver R can be used as an encryption password.

When all asynchronous queries have been processed, the sender S can generate a new password. This means that any currently occurring transmissions can be completed, even after a cold start.

It is also conceivable, however, to extend the protocol by a once-only password per transfer. This allows the sender-side traffic to be encrypted and buffered, with the key being immediately discarded again. The data can no longer be read on the transmitter S side and can only be de-encrypted by the receiver R.

FIG. 3 a) shows a flowchart of the transfer of data as short messages SMS in a voice channel of a mobile radio telephone network.

In this example, the sender S has a computer program, hereafter referred to as a client, wherein part of the functionality controls the SMS data transfer (SMS-CLIENT).

After the initialization of a synchronization request (IN IT) to the receiver R (SERVER), it is checked whether the initialization request has arrived there. If a connection via the internet is not possible after a specified waiting period Time-Out, the procedure for transmitting the data as data messages in a synchronization channel (or voice channel) SMS is started (SMS-PROC). The asynchronous processing of the data is then initiated (ASYNC) in the SMS module.

To do this, a data synchronization request is first sent as a data message via the synchronization channel (SMS) to the receiver R (SMS-SERVER). There the data message SMS is received and the synchronization is started (Update). In addition, a confirmation data message is sent back to the client via the synchronization channel to acknowledge receipt of the synchronization request (ACK). This confirmation message (ACK) is received by the client (REC). There, the system waits for the data packets to be received ( - - - ). For the synchronization process (Update), the synchronization process is started in the server and the data to be synchronized is read from the assigned database (for the central server, the central database 2 and for a mobile terminal 5 as the server, the distributed database 7) and transferred to the function routine SMS-THREAD. There, the data is buffered in a local memory and further processed (packets). The data to be transferred is prioritized and encrypted, recoded and packaged in accordance with the priority.

An IP data packet is transmitted with a plurality of data messages SMS, wherein a group of data messages are logically combined to form an IP data packet. To do this, a first short data message SMS with metadata is transmitted from the server to the client, which message contains the content, the number and, if appropriate, additional information about the associated SMS text messages. This SMS metadata is received by the client, and the receipt is confirmed again with an SMS text message to the server (ACK).

After the confirmation message is received, the server with the SMS-THREAD functionality transmits the associated data messages P1, P2, P3 that together form an IP data packet.

FIG. 3b) describes the continuation of the method of FIG. 3a) after the transmission of the second SMS data message P2. The third SMS data message P3 has encountered data transmission problems during transmission (Time-Out). This data message could not be delivered. Therefore, the SMS-THREAD sends a message indicating the end of transmission of the associated data packet (FIN) to the client, which receives this message and confirms it with a confirmation message (ACK) to the SMS-THREAD. The finalization confirmation contains the identification of the still missing packets which is known from the receipt of the SMS metadata.

The SMS-THREAD then transmits the missing SMS data messages after receiving the finalization confirmation, as described in this section along with the example SMS-P3 for the third data message. However, further data packets can be transferred in sequence as shown in FIG. 3a).

After the transmission of the set of data messages associated with the SMS metadata is complete, a finalization message FIN is sent by the SMS-THREAD to the client, which receives it (REC) and acknowledges receipt with a confirmation message (ACK). This completes the task of the SMS-THREAD for this data packet.

The SMS-CLIENT then passes the subsequent processing over to the client, which evaluates the received SMS data messages in order to update its database. For this purpose, the received SMS text messages can be analyzed, for example with a parser, and assembled in such a way that the data in the database is updated in an automated, computer-controlled process.

FIG. 4 shows an extended first part of the process according to FIG. 3a) of the data transmission for synchronizing data, preceded by an exchange of management data. After this, the data packet exchange SMS P1, SMS P2, . . . is carried out according to the last two steps of FIG. 3a) and the steps of FIG. 3b).

Before this data packet transmission, a transmission of management data is provided.

As in FIG. 3a), after the initialization of a synchronization request (INIT) to the receiver R (SERVER), a check is first made to determine whether the initialization request has arrived there. If a connection via the internet is not possible after a specified waiting period Time-Out, the procedure for transmitting the data as data messages in a synchronization channel (or voice channel) SMS is started (SMS-PROC). The asynchronous processing of the data is then initiated (ASYNC) in the SMS module.

To do this, a data synchronization request is first sent as a data message via the synchronization channel (SMS) to the receiver R (SMS-SERVER). There the data message SMS is received and the synchronization is started (Update). In addition, a confirmation data message is sent back to the client via the synchronization channel to acknowledge receipt of the synchronization request (ACK). This confirmation message (ACK) is received by the client (REC).

The SMS client then transmits the management data P1, . . . , Pn via channel a) to the SMS server, for example as an SMS. The receipt is checked and confirmed there. After the transmission of the management data packets is completed, the sender (in this case, e.g., the SMS client) transmits a finalization message FIN to the receiver, which confirms it ACK FIN and starts the update process Update.

The SMS client, after receiving REC the confirmation of receipt of the finalization message, waits for the data packets to be received ( - - - ). For the synchronization process (Update), the synchronization process is started in the server and the data to be synchronized are read from the assigned database (for the central server, the central database 2 and for a mobile terminal 5 as the server, the distributed database 7) and transmitted to the function routine SMS-THREAD. There, the data is buffered in a local memory and further processed (packets). This involves the data items to be transferred being prioritized and encrypted, recoded and packaged in accordance with the priority.

The management data can be transmitted from the receiver of the data packets P1, P2, P3, Pn to the sender of the data packets, for example, to exchange a cryptographic key. This is useful, for example, to exchange a public key for the asynchronous encryption of the data packets P1, P2, P3, . . . etc. The management data transmitted can also consist of the number of data packets pending or requested for transmission, their respective checksums, and/or an entire checksum over all data packets to be transmitted. For this purpose, this management data can also be transferred from the sender of the later data packets P1, P2, P3, . . . to the receiver, i.e. the reverse of the communication as shown in FIG. 4.

An update is not only intended to mean a change in the corresponding existing data, but also extending the database with new data or deleting existing data.

The callback and the branching back to the additional functionality of the server allow processing to return to the initialization phase for each additional data packet to be updated, in order to determine whether a data transmission channel for IP-based data transmission over the internet is available again. This has the advantage that much faster and cost-effective synchronization is possible via IP-based data packet transmission. The amount of data and the transmission time are significantly limited when transmitting data as data messages in a synchronization channel or voice channel of a mobile radio telephone network. This option should therefore only be used for high-priority data and only when required.

The method can be implemented with a computer program that has various logical functional components.

These include encryption/de-encryption.

A function component for data packet management may also be present.

A function component for establishing a connection can be provided for the use of the synchronization or voice channel of a mobile radio telephone network.

It is also advantageous if a function component for managing the individual function calls of the computer program is present, which coordinates the individual functions and the processing in a processor.

A function component for assembling the data messages into the SMS transport protocol may also be present.

At least two protocol layers can be implemented for the synchronization. An upper protocol layer is responsible for the content of the data to be synchronized and deals with what needs to be transferred from a technical point of view. Since both the query, response and also transmission of the data run asynchronously, a corresponding control layer at the lower protocol level is also useful. This may comprise an SMS announcement, transmission of the individual SMS data messages and of the SMS finalization announcement, in order to create these data messages from the data provided by the higher protocol level and in particular to initiate the transmission.

The higher protocol level can be used to create a synchronization query and a parameterization with the values from an original synchronization query. Encryption, recoding and compression of the query data are also performed. The individual data messages SMS transmitted in the synchronization or voice channel can contain a checksum, the packet type, the packet number, and a query number in addition to the user data. The transmission acknowledgment ACK can also contain a checksum, the number of received packets, and a query number.

During initialization, a key announcement can be transmitted with a data message, containing an AES password for data communication encrypted with a public key, and a checksum.

The receipt of the key can be confirmed with a checksum over the received AES password, which is encrypted with the AES password.

The SMS metadata can comprise information about the number of packets, the query number, and the number of delivery attempts carried out to date, as well as a checksum over all packet contents. Confirmation of this transmission announcement can comprise a checksum of the transmission packet in addition to the query number and the number of packets.

The finalization can be announced with a data message that includes the number of packets to be transmitted, the query number, the number of delivery attempts made so far, and a checksum over all packet contents.

This finalization announcement can be confirmed with a data message that includes the number of data packets, the query number and user data, as well as a checksum. The identifiers of the missing data messages can be transmitted as user data.

These different types of data messages can be identified with a suitable identifier in the respective data message.

The method for synchronizing data in databases can be used not only to transmit created or modified productive data to the server, e.g. for new cases, and to retrieve productive data from the server to the mobile terminal, e.g. for cases and contacts etc. It can also be used to retrieve infrastructure data from the server, e.g. information about health facilities and users.

The synchronization method also allows data communication over a non-IP data connection. It supplies information about permitted and remaining data based on configurations performed on the server module as well as information about the quality and bandwidth of the available data connections. It enables asynchronous sending of data and registration of listeners which can process the response.

The computer program running on the client handles the packet management to send data of any size and to ensure that no data is lost. The service receiving the responses can run in the background, so that the application does not have to be constantly active.

Subscribers can be re-registered for outstanding requests so that they can still be processed if the application is terminated unexpectedly or by the user. Requests can be automatically canceled if no response is received for a defined period of time. It is advantageous if the answers use http-status codes to provide information about successes or communication problems. The data can be received by a background service without having to be actively searched for. The recipients registered for this service allow the application to process this data.

The mobile terminal 5 can be configured at the factory as a mobile telephone to transmit a voice message as a short message via the synchronization or voice channel. The central server 1, on the other hand, can be configured via a mobile telephone connected to it or via an IP connection to a service provider or gateway device, to enable the sending and/or receipt of data as a short message SMS in a synchronization or voice channel of a mobile radio telephone network.

It is possible to receive data that has been divided into a plurality of short messages and that may have been compressed and encrypted. In addition, authentication of transactions based on the SMS metadata or authorization protocols and, if applicable, the telephone number of the mobile terminal transmitting the short message can be enabled.

For example, a reported infection case can be identified with basic information about the associated disease, the report date, the person's name, and a UID (Universal Unique Identifier) and transmitted as high-priority data. The identifier UID can be used later when an internet data connection becomes available again, to merge the basic case data with the complete case data.

In addition to full reporting for infection outbreak control, weekly reporting from the mobile device to the server is also possible. This weekly report can include the number of infection cases reported by the user in the last week.

If the user has not been online via an internet connection for a certain period of time, the data should be sent with high priority as a short message to the user's mobile device. To do this, the server must know the last time each user was online and which device is associated with that user. This information is collected and evaluated by the server accordingly.

Results of a central laboratory examination should have a high priority. When an infection evaluation laboratory has submitted an examination result to the server 1, it is important to inform the users working on-site as quickly as possible. This can then take place with the aid of text messages SMS.

1. A method for synchronizing data from one or more databases a in one or more mobile terminals with data in a central database, wherein data is transmitted between a mobile terminal of the one or more mobile terminals and the central database optionally via the following data transmission channels:
channel a)—data messages in a signaling channel or voice channel of a mobile radio telephone network,
channel b)—IP data packet in a data channel of the mobile radio telephone network for data transmission via the Internet, or
channel c)—IP data packet in a wireless local access network for data transmission via the internet,
comprising:
checking availability of data transmission channels via the internet according to channel b) via IP data packets with the data channel of the mobile radio telephone network or channel c) via IP data packets in the wireless local access network, and
if the data transmission channels are available,
synchronizing the one or more databases of the one or mobile terminals with the central database via the available channel b) or c) for IP data packets, and
if the data transmission channels are not available
prioritizing for synchronization of the data to be transmitted,
dividing the data to be transmitted with the highest priority into data messages; and
transmitting the data messages to be transmitted with the highest priority in channel a) as data messages in the signaling channel or voice channel of the mobile radio telephone network.

2. The method as claimed in claim 1, wherein if the data transmission channels are not available via the internet according to channel b) via IP data packets with the data channel of the mobile radio telephone network or channel c) via IP data packets in the wireless local access network, the data to be transmitted is transferred to a separate software application on a mobile terminal of the one or more mobile terminals or on a central computer accessing the central database, and wherein the steps
prioritizing for synchronization of the data to be transmitted,
dividing the data to be transmitted with the highest priority into data messages;
transmitting the data messages to be transmitted with the highest priority in channel a) as data messages in the signaling channel or voice channel of the mobile radio telephone network
are carried out by the separate software application.

3. The method as claimed in claim 1 further comprising transmitting a confirmation message back after error-free receipt of a data message in the signaling or voice channel of the mobile radio telephone network and repeating the transmission of the data message if no confirmation message has been received within a specified time.

4. The method as claimed in claim 3 wherein for the transmission of data from the central database to at least one mobile terminal device an availability of a data transmission channel via the internet according to channel b) or channel c) is checked on a basis of receipt of confirmation messages for error-free reception of data packets.

5. The method as claimed in claim 4, wherein after a data packet has been transmitted via the internet one or more times over the data transmission channel according to channel b) or channel c) without receiving a confirmation message, the data packets are prioritized and transmitted as data messages in a signaling or voice channel of the mobile radio telephone network according to their priority.

6. The method as claimed in claim 1 wherein in channel a) a short message service (SMS) of a terrestrial mobile radio telephone network or a satellite communication network is used for the transmission of the data messages via the signaling channel of a mobile radio telephone network.

7. The method as claimed in claim 1 further comprising monitoring a spread of one or more infections by exchanging data on the spread of one or more infections between the one or more mobile terminal devices and the central database.

8. The method as claimed in claim 7, wherein data about a result of an infection test relating to an individual case of infection is transmitted with high priority, wherein if a data transmission network via the internet is not available the transmission is carried out by data messages in the signaling or voice channel of the mobile radio telephone network.

9. The method as claimed in claim 1 wherein before the transmission of the data messages to be transmitted with the highest priority in the channel a) as data messages in the signaling or voice channel of the mobile radio telephone network, a transmission of management data is carried out in the channel a) as data messages in the signaling or voice channel of the mobile radio telephone network.

10. A non-transitory computer medium encoded with a computer program comprising commands which, during execution of the computer program by a computer, cause the computer to execute the steps of a method as claimed in claim 1.

11. A device for processing data, comprising:
a server; and
a central database communicatively connected to the server, wherein the server is connected to the internet and to a short messaging service of a mobile radio telephone network for the bi-directional transmission of data via synchronization or voice channel for voice messages, and wherein the server is configured for executing a method as claimed in claim 1.

12. A mobile terminal for processing data, comprising a non-transitory computer medium as claimed in claim 10.

13. The method of claim 9 wherein the management data comprises one or more of cryptography keys, checksums, and the number of data packets to be transmitted.
